(19) United States
(12) Patent Application Publication
(10) Pub. No.: US 2025/0167936 A1
(43) Pub. Date: May 22, 2025

(54) NETWORK CONTROLLED SMALL GAP (NCSG) SCHEDULING ON A WIRELESS NETWORK

(71) Applicant: Apple Inc., Cupertino, CA (US)

(72) Inventors: Qiming Li, Beijing (CN); Dawei Zhang, Saratoga, CA (US); Yang Tang, San Jose, CA (US); Huaning Niu, San Jose, CA (US); Jie Cui, San Jose, CA (US); Manasa Raghavan, Sunnyvale, CA (US); Xiang Chen, Campbell, CA (US)

(21) Appl. No.: 18/834,971

(22) PCT Filed: Feb. 12, 2022
(86) PCT No.: PCT/CN2022/076122

§ 371 Date: Jul. 31, 2024

(51) Int. Cl. H04L 5/00; H04W 24/08; H04W 24/10; H04W 56/00

(52) U.S. Cl. CPC H04L 5/001; H04W 24/08; H04W 24/10; H04W 56/0055

(57) ABSTRACT

Disclosed are methods, systems, and computer-readable medium to perform operations including: receiving first signaling information from a first base station (BS), where the first signaling information indicates that a user equipment (UE) device is to determine an index of a first synchronization signal block (SSB) transmitted by a second BS to the UE device on a second component carrier, based on timing information regarding a first component carrier associated with the first BS; determining a first measurement window for measuring one or more characteristics of the first SSB, where the first measurement window is determined based on a first time offset value Δt₁ and an expected length of the first SSB and measuring the one or more characteristics of the first SSB on the second carrier during the first measurement window.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method includes: receiving, at a user equipment (UE) device, first signaling information from a first base station (BS), where the first signaling information indicates that the UE device is to determine an index of a first synchronization signal block (SSB) transmitted by a second BS to the UE device on a second component carrier, based on timing information regarding a first component carrier associated with the first BS; determining, by the UE device, a first measurement window for measuring one or more characteristics of the first SSB, where the first measurement window is determined based on first time offset value Δt₁ and an expected length of the first SSB; and measuring, by the UE device, the one or more characteristics of the first SSB on the second carrier during the first measurement window.

Implementations of this aspect can include one or more of the following features.

In some implementations, determining the first measurement window can include: determining that a start of the first measurement window is the first time offset value Δt₁ prior to a sequentially first symbol of a second SSB transmitted by the first BS to the UE device using the first component carrier; and determining that a length of the first measurement window is two times the first time offset value Δt plus the expected length of the first SSB.

In some implementations, the method can further include at least one of: transmitting data to the first BS outside of the first measurement window, or receiving data from the first BS outside of the first measurement window.

In some implementations, the method can include refraining from transmitting data to the first BS or receiving data from the first BS during the first measurement window.

In some implementations, the first time offset value Δt₁ can represent a difference in synchronization between (i) first wireless signals transmitted by the first BS to the UE device using the first component carrier, and (ii) second wireless signals transmitted by the second BS to the UE device using the second component carrier.

In some implementations, the first component carrier can be associated with a first subcarrier spacing (SCS), and the second component carrier can be associated with a second SCS different from the first SCS.

In some implementations, the first signaling information can indicate that a value of an information element deriveSSB-IndexFromCell-inter is true.

In some implementations, the expected length of the first SSB can be determined based on second signaling information transmitted by the first BS to the UE device.

In some implementations, the second signaling information can include an information element SSB-ToMeasure.

In some implementations, the first signaling information can further indicate that UE device is to determine an index of a third SSB transmitted by the second BS or a third BS to the UE device on the second component carrier or a third component carrier, based on the timing information regarding the first component carrier associated with the first BS. Further, the methdo can further include: determining, by the UE device, a second measurement window for measuring one or more characteristics of the third SSB, where the second measurement window is determined based on a second time offset value Δt₂ and an expected length of the third SSB; and measuring, by the UE device, the one or more characteristics of the third SSB on the second component carrier or the third component carrier during the second measurement window.

In some implementations, the method can further include: determining that the first measurement window at least partially overlaps the second measurement window; and responsive to determining that the first measurement window at least partially overlaps the second measurement window, merging the first measurement window and the second measurement window in a merged measurement window.

In some implementations, the method can further include at least one of: transmitting data to the first BS outside of the merged measurement window, or receiving data from the first BS outside of the merged measurement window.

In some implementations, the method can include refraining from transmitting data to the first BS or receiving data from the first BS during the merged measurement window.

In some implementations, at least one of the first time offset value Δt₁ or the second time offset value Δt₂ can represent a difference in synchronization between (i) wireless signals transmitted by the first BS to the UE device using the first component carrier, and (ii) wireless signals transmitted by the second BS to the UE device using the second component carrier.

In some implementations, the second time offset value Δt₂ can represent a difference in synchronization between (i) wireless signals transmitted by the first BS to the UE device using the first component carrier, and (ii) wireless signals transmitted by the third BS to the UE device using the third component carrier.

In some implementations, the first component carrier can be associated with a first subcarrier spacing (SCS), the second component carrier can be associated with a second SCS different from the first SCS, and the third component carrier can be associated with a third SCS different from the first SCS.

In some implementations, the first signaling information can indicate that a value of an information element deriveSSB-IndexFromCell-inter is true.

In some implementations, at least one of the expected length of the second SSB or the expected length of the third SSB can be determined based on second signaling information transmitted by the first BS to the UE device.

In some implementations, the second signaling information can include an information element SSB-ToMeasure.

In accordance with another aspect of the present disclosure, a method includes: receiving, at a user equipment (UE) device from a first base station (BS), first signaling information, where the first signaling information indicates that the UE device is to determine an index of each of a plurality of first synchronization signal blocks (SSBs) transmitted by a plurality of second BS to the UE device on a plurality of second component carriers, based on timing information regarding a first component carrier associated with the first BS; determining, by the UE device, a plurality of measurement windows for measuring one or more characteristics of the plurality of first SSBs, where each of the plurality of measurement windows is determined based on: a corresponding time offset value Δt, and an expected length of a corresponding one of the first SSBs; identifying, based on second signaling information received at the UE device from the first BS, a particular one of the plurality of second component carriers, and measuring, during a corresponding measurement window of the identified second component carrier, the one or more characteristics of a corresponding one of the first SSBs on the identified second component carrier.

Implementations of this aspect can include one or more of the following features.

In some implementations, determining each of the plurality of measurement windows can include: determining that a start of that measurement window is the corresponding time offset value Δt prior to a sequentially first symbol of a corresponding second SSB transmitted by the first BS to the UE device using a first component carrier; and determining that a length of that measurement window is two times the corresponding time offset value Δt plus the expected length of the corresponding one of the first SSBs.

In some implementations, the method can further include at least one of: transmitting data to the first BS outside of the plurality of measurement windows, or receiving data from the first BS outside of the plurality of measurement windows.

In some implementations, the method can further include refraining from transmitting data to the first BS or receiving data from the first BS during the plurality of measurement windows.

In some implementations, the time offset value Δt can present a difference in synchronization between (i) signals transmitted by the first BS to the UE device using the first component carrier, and (ii) at least one of signals transmitted by the plurality of second BS to the UE device using the plurality of second component carriers.

In some implementations, the first component carrier can be associated with a first subcarrier spacing (SCS), where each of the plurality of second component carriers is associated with a different respective SCS different from the first SCS.

In some implementations, the first signaling information can indicate that a value of an information element deriveSSB-IndexFromCell-inter is true.

In at least some implementations, a system includes: at least one processor; and memory storing instructions that, when executed by the at least one processor, cause the at least one processor to perform various operations, including one or more of the methods described herein.

In at least some implementations, one or more non-transitory computer-readable media store instructions that, when executed by at least one processor, cause the at least one processor to perform operations, including one or more of the methods described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network 100, in accordance with some embodiments.

FIGS. 2-4 illustrate example network controlled small gap (NCSG) scheduling restrictions.

FIG. 5A and 5B illustrate flowcharts of example methods, in accordance with some embodiments.

FIG. 6 illustrates a user equipment (UE), in accordance with some embodiments.

FIG. 7 illustrates an access node, in accordance with some embodiments.

### DETAILED DESCRIPTION

In general, a wireless communications network can include base stations deployed within several geographical areas (e.g., cells) and user equipment (UE) devices operating in one or more of the cells. Further, the base stations can coordinate communications with each of the UE devices based, at least in part, on signal measurement information obtained by each of the UE devices during operation. For example, each of the UE device can measure the characteristics of wireless signals transmitted by one or more of the base stations (e.g., a signal strength associated with the wireless signals, such as a Reference Signal Received Power, RSRP), and provide at least some of the measurements to one or more of the base stations for processing. This can be beneficial, for example, in determining which base station is to serve a particular UE device, and in determining when to handoff the UE device from one base station to another.

In some implementations, a UE device can be configured to obtain signal measurements during specific intervals of times (e.g., measurement gap periods), during which the UE device does not otherwise transmit to and/or receive data from base stations. In some implementations, at least some of the intervals of time can be signaled to the UE devices by the base stations. For example, a base station can serve one or more UE devices, and signal to each of those UE devices one or more network controlled small gaps (NCSGs) during which the UE devices are to conduct measurements of wireless signals transmitted by the serving base station and/or other base stations (e.g., one or more other base stations neighboring the serving base station).

Further, in some implementations, a wireless communications network can be configured such that information regarding a Synchronization Signal Block (SSB) transmitted by one base station can be derived based on timing information associated with another base station. For example, according to specifications established by the 3rd Generation Partnership Project Technical Specification Group (3GPP TSG) Radio Access Network Working Group 4 (RAN4), an information element deriveSSB-IndexFromCell-inter can be signaled to a UE device (e.g., by a base station) to inform the UE device that the SSB indexes of a target cell(s) on a frequency different from the serving cell frequency can be derived from a serving cell. Further, the information element deriveSSB-IndexFromCell-inter can signal which service cell to utilize to derive the SSB indexes.

Example techniques for scheduling NCSGs in conjunction with use of the information element deriveSSB-IndexFromCell-inter are described in further detail herein.

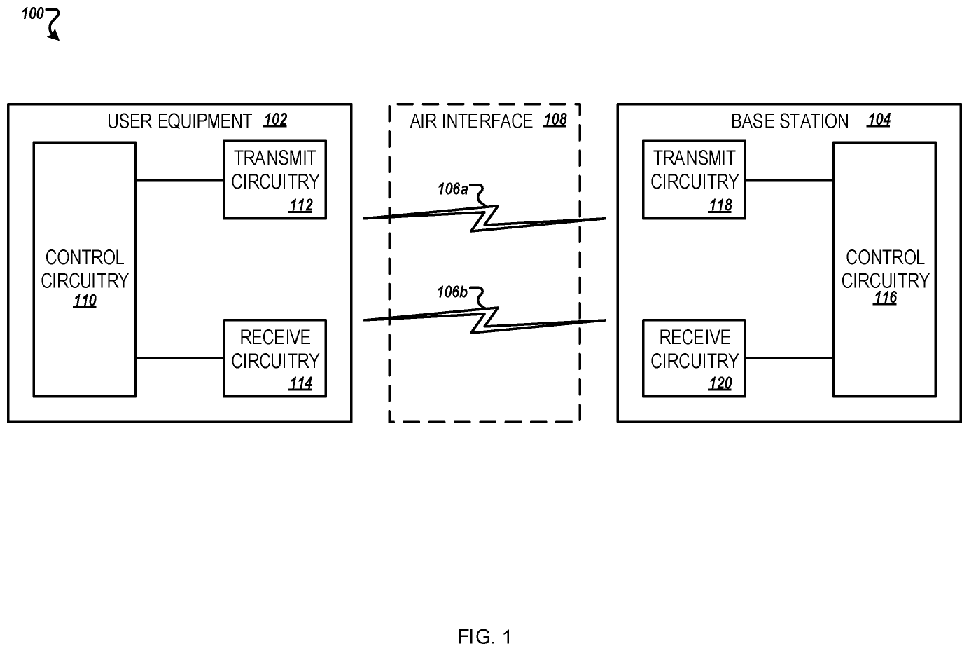

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, printers, machine-type devices such as smart meters or specialized devices for healthcare monitoring, remote security surveillance systems, intelligent transportation systems, or any other wireless devices with or without a user interface,. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations associated with selection of codecs for communication and to adaption of codecs for wireless communications as part of system congestion control. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry, including communications using codecs as described herein.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 118 and receive circuitry 120 may be adapted to transmit and receive data, respectively, to any UE connected to the base station 104 using data generated with various codecs described herein. The transmit circuitry 118 may transmit downlink physical channels including of a plurality of downlink subframes. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data via a ProSe interface. The ProSe interface may alternatively be referred to as a SL interface and may include one or more logical channels, including but not limited to a PSCCH, a PSSCH, a PSDCH, and a PSBCH.

As described above, a UE device 102 can be configured to obtain signal measurements during specific intervals of time (e.g., measurement gap periods), during which the UE device 102 does not otherwise transmit to and/or receive data from base stations (e.g., one or more base stations 104) on one frequency so that the UE 102 can conduct measurements of signals (e.g., on a different frequency). Further, the base stations 104 can coordinate communications with the UE device 102 based, at least in part, on signal measurement information obtained by the UE device 102 during operation. For example, the UE device 102 can measure the characteristics of wireless signals (e.g., Synchronization Signal Blocks, SSBs) transmitted by one or more of the base stations 104 (e.g., a signal strength associated with the wireless signals, such as a Reference Signal Received Power, RSRP), and provide at least some of the measurements to one or more of the base stations 104 for processing. This can be beneficial, for example, in determining which base station 104 is to serve the UE device 102, and in determining when to handoff the UE device 102 from one base station 104 to another.

Further, in some implementations, at least some of the intervals of time can be signaled to the UE device 102 by one or more of the base stations 104. For example, a base station 104 that is serving the UE device 102 can signal to the UE device 102 one or more network controlled small gaps (NCSGs) during which the UE device 102 is to conduct measurements of wireless signals transmitted by the serving base station and/or other base stations (e.g., one or more other base stations neighboring the serving base station).

Further, in some implementations, a wireless communications network can be configured such that information regarding an SSB transmitted by one base station 104 can be derived, without further explicit signaling, based on timing information associated with another base station 104. For example, according to specifications established by 3GPP TSG RAN4 (e.g., as discussed in RAN4 #101-bis-e), an information element deriveSSB-IndexFromCell-inter can be signaled to a UE device 102 (e.g., by a base station 104) to inform the UE device 102 that the SSB indexes of a target cell(s) on a frequency different from the serving cell frequency can be derived from a serving cell (e.g., using a “true” flag or value for the information element). Further, the information element deriveSSB-IndexFromCell-inter can signal which service cell to utilize to derive the SSB indexes.

In some implementations, deriveSSB-IndexFromCell-inter can be signaled on a measurement object (MO) by MO basis (e.g., a carrier by carrier basis). For instance, a serving base station can signal to a UE one or more instances of deriveSSB-IndexFromCell-inter, each instance indicating whether the SSB indexes of a target cell(s) on a respective carrier can be derived from a serving cell. As an example, base station can signal to a UE a first instance of deriveSSB-IndexFromCell-inter for a first carrier, indicating that the SSB indexes of a target cell(s) on the first carrier can be derived from a serving cell (e.g., by signaling that deriveSSB-IndexFromCell-inter is true). As another example, base station can signal to a UE a second instance of deriveSSB-IndexFromCell-inter for a second carrier, indicating that the SSB indexes of a target cell(s) on the second carrier cannot be derived from a serving cell (e.g., by signaling that deriveSSB-IndexFromCell-inter is false).

In some embodiments, deriveSSB-IndexFromCell-inter can only be configured if the subcarrier spacing (SCS) of a SSB is the same between the target cell and the serving cell that is used for SSB indexes derivation.

In some embodiments, when the wireless communication network enables deriveSSB-IndexFromCell-inter, the UE device can assume frame boundary alignment (including half frame, subframe and slot boundary alignment) across cells on the same frequency carrier is within a particular tolerance not worse than Δt (e.g., a difference in synchronization between cells, such as due to propagation delays) and the System Frame Numbers (SFNs) of all cells on the same frequency carrier are the same. In some implementations, Δt can be equal to one symbol. In some implementations, Δt can be equal to any other number of symbols (e.g., two, three, four, etc.). In some implementations, the symbol duration can be determined by numerology of SSB from the serving cell, or PDSCH from serving cell, or the SSB from the target cell.

Various techniques can be used to schedule NCSGs in conjunction with use of the information element deriveSSB-IndexFromCell-inter. In some implementations, these techniques may be referred to as NCSG scheduling restrictions (e.g., guidelines that specify the scheduling of data transmission/reception during NCSGs, such as which symbol(s) during NCSGs can and/or cannot be scheduled).

In some embodiments, a particular set of NCSG scheduling restrictions can be used in conjunction with wireless communications in frequency bands within Frequency Range 1 (FR1).

For example, when scheduling NCSGs for intra-frequency measurements in FR1, certain pre-existing scheduling restriction requirements may apply (e.g., as specified by 3GPP Technical Specification (TS) 38.133, the contents of which are incorporated by reference in their entirety).

Further, when scheduling NCSGs for intra-bend inter-frequency measurements in FR1, if deriveSSB-IndexFromCell-inter is false, the pre-existing scheduling restriction requirements may apply (e.g., as specified by 3GPP TS 38.133), with the exception that all symbols in SS/PBCH Block Measurement Timing Configuration (SMTC) windows are restricted. However, if deriveSSB-IndexFromCell-inter is true, for single component carrier (CC) and single measurement object (MO) (e.g., single carrier) use cases, pre-existing scheduling restriction requirements may apply (e.g., as specified by 3GPP TS 38.133 clause 9.3.9.3).

Further, when scheduling NCSGs for inter-band measurements in FR, there may be no scheduling restrictions for UE device that support simultaneous Rx/Tx. However, certain scheduling restrictions may apply for UE devices that do not support simultaneous Rx/Tx. For example, if deriveSSB-IndexFromCell-inter is false, pre-existing scheduling restriction requirements may apply (e.g., as specified by 3GPP TS 38.133), except that all symbols in the SMTC windows are restricted. Further, if deriveSSB-IndexFromCell-inter is true, for single CC and single MO use cases, pre-existing scheduling restriction requirements may apply (e.g., as specified by 3GPP TS 38.133 clause 9.3.9.3).

In some embodiments, another set of NCSG scheduling restrictions can be used in conjunction with wireless communications in frequency bands within Frequency Range 2 (FR2).

For example, when scheduling NCSGs for intra-frequency measurements in FR2, pre-existing scheduling restriction requirements may apply (e.g., as specified by 3GPP TS 38.133 clause 9.3.9.3).

Further, when scheduling NCSGs for intra-band inter-frequency measurements in FR2, if deriveSSB-IndexFromCell-inter is false, pre-existing scheduling restriction requirements may apply (e.g., as specified by 3GPP TS 38.133 clause 9.3.9.3), except that all symbols in SMTC windows are restricted. However, if deriveSSB-IndexFromCell-inter is true, for single CC and single MO use cases, pre-existing scheduling restriction requirements may apply (e.g., as specified by 3GPP TS 38.133 clause 9.3.9.3).

Further, when scheduling NCSGs for inter-band measurement in FR2 and when the serving band and the target band are managed by common beam management (CBM), if deriveSSB-IndexFromCell-inter is false, pre-existing scheduling restriction requirements may apply (e.g., as specified by 3GPP TS 38.133 clause 9.3.9.3), except that all symbols in SMTC windows are restricted. However, if deriveSSB-IndexFromCell-inter is true, for single CC and single MO use cases, pre-existing scheduling restriction requirements may apply (e.g., as specified by 3GPP TS 38.133 clause 9.3.9.3).

Further, when scheduling NCSGs for inter-band measurement in FR2 and when the serving band and the target band are managed by independent beam management (IBM), no scheduling restrictions may apply for UE devices supporting simultaneous Rx/Tx. However, certain scheduling restrictions may apply for UE devices that do not support simultaneous Rx/Tx. For example, if deriveSSB-IndexFromCell-inter is false, pre-existing scheduling restriction requirements may apply (e.g., as specified by 3GPP TS 38.133 clause 9.3.9.3), except that all symbols in SMTC windows are restricted. However, if deriveSSB-IndexFromCell-inter is true, for single CC and single MO use cases, pre-existing scheduling restriction requirements may apply (e.g., as specified by 3GPP TS 38.133 clause 9.3.9.3).

Additional NCSG scheduling restrictions can be implemented when deriveSSB-IndexFromCell-inter is true and when the UE is configured with multiple CCs and/or multiple MOs. For example, particular NCSG scheduling restrictions can be implemented when the SCS of a SSB is different between target cell and the serving cell which is used for SSB indexes derivation. Example NCSG scheduling restrictions are described in further detail below.

### Example 1—NCSG Scheduling Restrictions for Single MO, Different SCSs

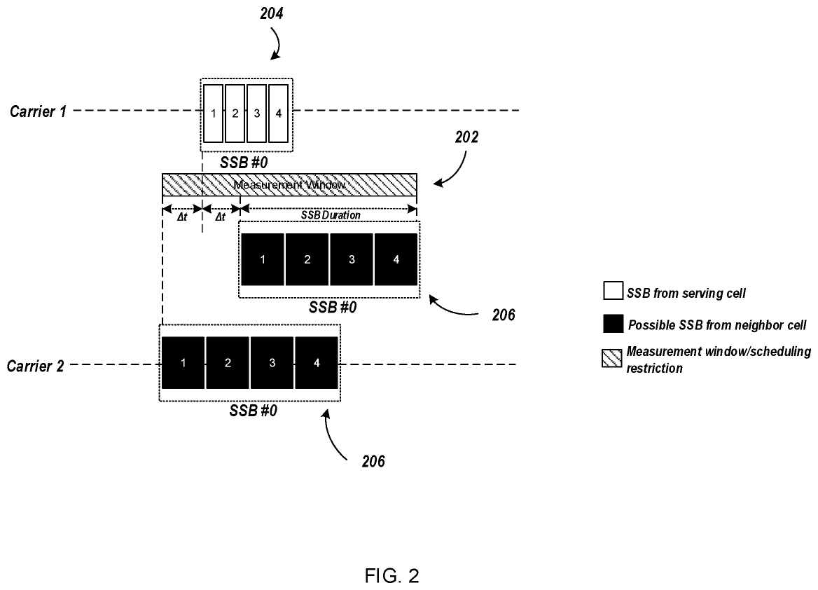

FIG. 2 shows an example NCSG scheduling restriction that can be implemented for use cases having a single MO (e.g., a single carrier to be measured), where the carrier of the serving cell has a different SCS than the carrier that is to be measured.

In this example, the carrier of the serving base station (“Carrier 1”) has a first SCS, and the carrier from a neighboring base station (“Carrier 2”) that is to be measured has a second SCS that is different from the first SCS. For example, the SCS of Carrier 1 can have an SCS that double the SCS of Carrier 2. Correspondingly, the symbols transmitted on Carrier 1 can have a duration that is one half the duration of symbols transmitted on Carrier 2.

Further, a NCSG scheduling restriction can be implemented, whereby the UE device is instructed to measure the characteristics of wireless signals (e.g., SSBs) transmitted on Carrier 2 during a particular measurement window 202. The measurement window 202 can start from the first symbol (e.g., orthogonal frequency division multiplexing, ODFM symbol) of the SSB 204 transmitted on Carrier 1, minus a time offset Δt. Further, the length of the measurement window 202 can be two times the time offset Δ, plus an expected length of the SSB 206 transmitted on Carrier 2. The time offset Δt represents a difference in synchronization between cells, such as due to propagation delays. For example, the time offset Δt can represent a difference in synchronization between wireless signals transmitted by the serving base station (e.g., on Carrier 1) and wireless signals transmitted by the neighboring base station (e.g., on Carrier 2).

In some implementations, the first symbol of the SSB 204 transmitted on Carrier 1 and/or the expected length of the SSB 206 transmitted on Carrier 2 can be signaled to the UE device (e.g., using an information element SSB-ToMeasure transmitted to the UE device by a serving base station).

Further, if the starting and/or ending point of the measurement window 202 partially overlaps with the symbol on the serving carrier(s), the whole symbol can be restricted (e.g., such that measurements are not scheduled occur during that symbol).

Further, the UE device can transmit and/or receive data outside of the measurement window 202, without interrupting the measurements made during the scheduled NCSGs. For example, the UE can transmit data to one or more base stations (e.g., a serving base station) and/or receive data from one or more base stations (e.g., the service base station) during one or more intervals of time that are not within the measurement window 202.

### Example 2—NCSG Scheduling Restrictions for Multiple MOs, Same or Different SCSs

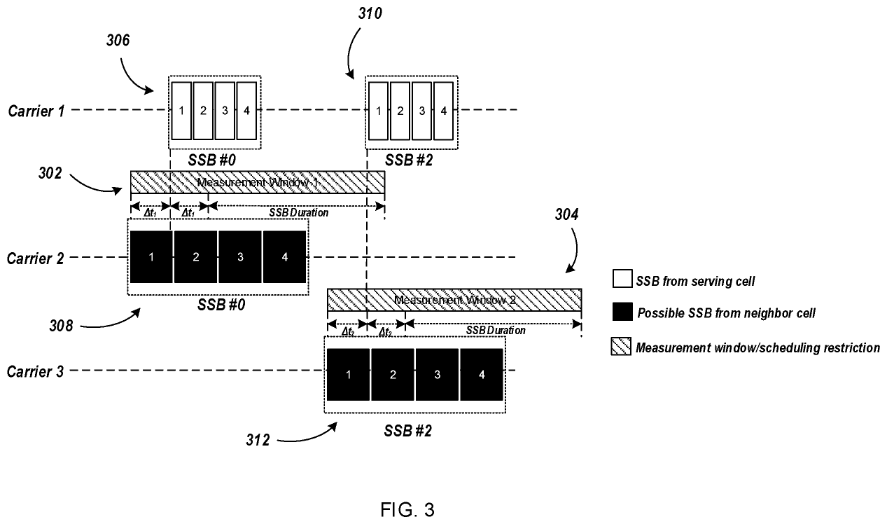

FIG. 3 shows an example NCSG scheduling restriction that can be implemented for use cases having multiple MOs (e.g., multiple carriers to be measured), where the carrier of the serving cell has the same SCS or a different SCS than the carriers that are to be measured.

In this example, the carrier of the serving base station (“Carrier 1”) has a first SCS. Further, the carrier from a neighboring base station (“Carrier 2”) that is to be measured has a second SCS that is different from the first SCS. Further, the carrier from another neighboring base station (“Carrier 3”) that is to be measured has a third SBS that is different from the first SCS. For example, the SCS of Carrier 1 can have an SCS that double the SCSs of Carriers 2 and 3. Correspondingly, the symbols transmitted on Carrier 1 can have a duration that is one half the duration of symbols transmitted on Carriers 2 and 3.

Further, a NCSG scheduling restriction can be implemented, whereby the UE device is instructed to measure the characteristics of wireless signals (e.g., SSBs) transmitted on Carrier 2 during a first measurement window 302, and to measure the characteristics of wireless signals (e.g., SSBs) transmitted on Carrier 3 during a second measurement window 304.

In a similar manner as described with reference to Example 1, the first measurement window 302 can start from the first symbol of a corresponding SSB 306 transmitted on Carrier 1, minus a first time offset Δt₁. Further, the length of the first measurement window 302 can be two times the first time offset Δt₁, plus an expected length of the SSB 308 transmitted on Carrier 2. The first time offset Δt₁ represents a difference in synchronization between cells, such as due to propagation delays. For example, the first time offset Δt₁ can represent a difference in synchronization between wireless signals transmitted by the serving base station (e.g., on Carrier 1) and wireless signals transmitted by one of the neighboring base station (e.g., on Carrier 2).

In some implementations, the first symbol of the SSB 306 transmitted on Carrier 1 and/or the expected length of the SSB 308 transmitted on Carrier 2 can be signaled to the UE device (e.g., using an information element SSB-ToMeasure transmitted to the UE device by a serving base station).

Further, the second measurement window 304 can start from the first symbol of a corresponding SSB 310 transmitted on Carrier 1, minus a second time offset Δt₂. Further, the length of the second measurement window 304 can be two times the second time offset Δt₂, plus an expected length of the SSB 312 transmitted on Carrier 3. The second time offset Δt₂ represents a difference in synchronization between cells, such as due to propagation delays. For example, the second time offset Δt₂ can represent a difference in synchronization between wireless signals transmitted by the serving base station (e.g., on Carrier 1) and wireless signals transmitted by the other one of the neighboring base station (e.g., on Carrier 3).

In some implementations, the first symbol of the SSB 310 transmitted on Carrier 1 and/or the expected length of the SSB 312 transmitted on Carrier 3 can be signaled to the UE device (e.g., using an information element SSB-ToMeasure transmitted to the UE device by a serving base station).

Further, if the starting and/or ending point of the measurement windows 302 and/or 304 partially overlaps with the symbol on the serving carrier(s), the whole symbol can be restricted (e.g., such that measurements are not scheduled occur during that symbol).

Further, the UE device can transmit and/or receive data outside of the first measurement window 302 and the second measurement window 304, without interrupting the measurements made during the scheduled NCSGs. For example, the UE device can transmit data to one or more base stations (e.g., a serving base station) and/or receive data from one or more base stations (e.g., the service base station) during one or more intervals of time that are not within either the first measurement window 302 or the second measurement window 304.

Further, in some implementations, the UE device can merge multiple measurement windows together. For example, the UE device can determine that two or more measurement windows at least partially overlap one another in time, and in response, merge those measurement windows into a single merged measurement window. Further, the UE device can transmit and/or receive data outside of the merged measurement window, without interrupting the measurements made during the scheduled NCSGs.

Although FIG. 3 shows an example use case with two MOs (e.g., two carriers to be measured), in practice, the scheduling restrictions described herein can be implemented with any number of MOs (e.g., one, two, three, four, or more).

In some implementations, the wireless communications network can also signal the UE device to measure certain MOs (e.g., certain carriers) during each of the measurement windows.

As an example, a wireless communications network (e.g., via a serving base station) can signal the UE using a set of configuration information that indicates, in a sequence, the MO that is to be measured for each successive measurement window. For instance, a set of configuration information {MOₐ, MO_{b}, MO_{c}, . . . , MOₓ} can indicate that the UE is to measure MOₐ, MO_{b}, MO_{c}, . . . , MOₓ in a sequence, where x is the maximum number of configured MOs. In some implementations, x can be equal to 8. In some implementations, x can be equal to 32. Other values of x are also possible, depending on the implementation.

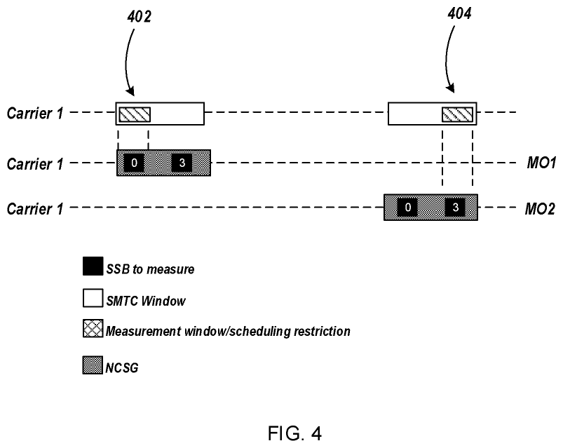

For example, FIG. 4, shows an example NCSG scheduling restriction that can be implemented for use cases having multiple MOs (e.g., multiple carriers to be measured), where the carrier of the serving cell has the same SCS or a different SCS than the carriers that are to be measured.

In this example, the wireless communications network (e.g., via a serving base station) signals the UE device to measure a first MO (e.g., MO1, corresponding to Carrier 2) during a first measurement window 402, and to measure a second MO (e.g., MO2, corresponding to Carrier 3) during a second measurement window 404. Based on the signaling, the UE device measures the first MO during the first measurement window 402, and measures the second MO during the second measurement window 404.

In some implementations, the first measurement window in a sequence can be the first NCSG occasion in time after a Radio Resource Control (RRC). In some implementations, the first measurement window in a sequence can the first NCSG occasion in time after SFN=0 and Slot 0.

Although FIG. 4 shows an example use case with two MOs (e.g., two carriers to be measured), in practice, the scheduling restrictions described herein can be implemented with any number of MOs (e.g., one, two, three, four, or more).

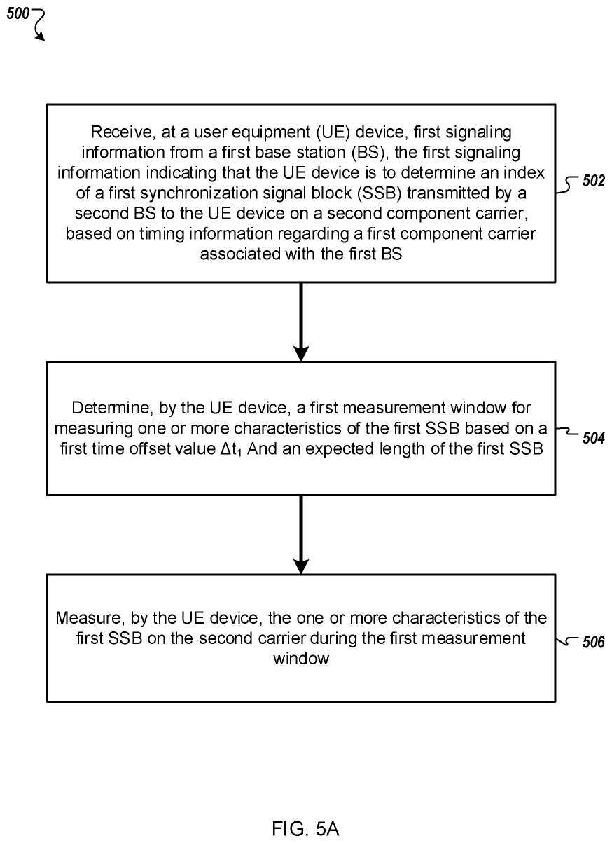

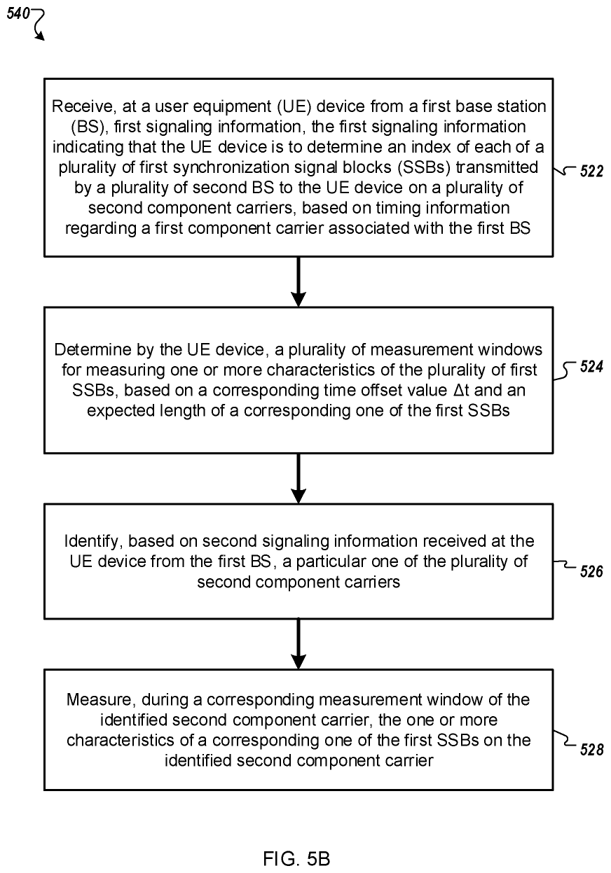

FIG. 5A illustrates a flowchart of an example method 500, according to some implementations. For clarity of presentation, the description that follows generally describes method 500 in the context of the other figures in this description. For example, method 500 can be performed by the UE device 102 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

According to the method 500, a user equipment (UE) device receives first signaling information from a first base station (BS) (block 502). The first signaling information indicates that the UE device is to determine an index of a first synchronization signal block (SSB) transmitted by a second BS to the UE device on a second component carrier, based on timing information regarding a first component carrier associated with the first BS.

In some implementations, the first component carrier can be associated with a first subcarrier spacing (SCS), and the second component carrier can be associated with a second SCS different from the first SCS.

In some implementations, the first signaling information can indicate that a value of an information element deriveSSB-IndexFromCell-inter is true.

The UE device determines a measurement window for measuring one or more characteristics of the first SSB (block 504). The first measurement window is determined based on a first time offset value Δt₁ and an expected length of the first SSB.

In some implementations, determining the measurement window includes determining that a start of the first measurement window is a first time offset value Δt₁ prior to a sequentially first symbol of a second SSB transmitted by the first BS to the UE device using the first component carrier, and determining that a length of the first measurement window is two times the first time offset value Δt₁ plus an expected length of the first SSB.

In some implementations, the expected length of the first SSB can be determined based on second signaling information transmitted by the first BS to the UE device. As an example, the second signaling information can include an information element SSB-ToMeasure.

In some implementations, the first time offset value Δt₁ can represent a difference in synchronization between (i) first wireless signals transmitted by the first BS to the UE device using the first component carrier, and (ii) second wireless signals transmitted by the second BS to the UE device using the second component carrier.

The UE device measures the one or more characteristics of the first SSB on the second carrier during the first measurement window (block 506).

In some implementations, the method 500 can also include transmitting data to the first BS outside of the first measurement window and/or receiving data from the first BS outside of the first measurement window. Further, the method 500 can also include refraining from transmitting data to the first BS or receiving data from the first BS during the first measurement window.

In some implementations, the first signaling information can further indicate that UE device is to determine an index of a third SSB transmitted by the second BS or a third BS to the UE device on the second component carrier or a third component carrier, based on the timing information regarding the first component carrier associated with the first BS.

Further, the method 500 can include determining, by the UE device, a second measurement window for measuring one or more characteristics of the third SSB, where the second measurement window is determined based on a second time offset value Δt₂ and an expected length of the third SSB. Further, the method 500 can include measuring, by the UE device, the one or more characteristics of the third SSB on the second component carrier or the third component carrier during the second measurement window.

In some implementations, the first component carrier can be associated with a first subcarrier spacing (SCS), the second component carrier can be associated with a second SCS different from the first SCS, and the third component carrier can be associated with a third SCS different from the first SCS.

In some implementations, determining the second measurement window can include: determining that a start of the second measurement window is the second time offset value Δt₂ prior to a sequentially first symbol of a fourth SSB transmitted by the first BS to the UE device using the first component carrier. Further, determining the second measurement window can include determining that a length of the second measurement window is two times the second time offset value Δt₂ plus the expected length of the third SSB.

In some implementations, at least one of the first time offset value Δt₁ or the second time offset value Δt₂ can represent a difference in synchronization between (i) wireless signals transmitted by the first BS to the UE device using the first component carrier, and (ii) wireless signals transmitted by the second BS to the UE device using the second component carrier.

In some implementations, the second time offset value Δt₂ can represent a difference in synchronization between (i) wireless signals transmitted by the first BS to the UE device using the first component carrier, and (ii) wireless signals transmitted by the third BS to the UE device using the third component carrier.

In some implementations, the first signaling information can indicate that a value of an information element deriveSSB-IndexFromCell-inter is true.

In some implementations, at least one of the expected length of the second SSB or the expected length of the third SSB can be determined based on second signaling information transmitted by the first BS to the UE device. As san example, the second signaling information can include an information element SSB-ToMeasure.

In some implementations, the method 500 can further include determining that the first measurement window at least partially overlaps the second measurement window, and in response, merging the first measurement window and the second measurement window in a merged measurement window.

In some implementations, the method 500 can include transmitting data to the first BS outside of the merged measurement window and/or receiving data from the first BS outside of the merged measurement window. Further, the method 500 can include refraining from transmitting data to the first BS or receiving data from the first BS during the merged measurement window.

FIG. 5B illustrates a flowchart of an example method 520, according to some implementations. For clarity of presentation, the description that follows generally describes method 520 in the context of the other figures in this description. For example, method 520 can be performed by the UE device 102 of FIG. 1. It will be understood that method 520 can be performed, for example, by any suitable system, environment, software, hardware, or a combination of systems, environments, software, and hardware, as appropriate. In some implementations, various steps of method 520 can be run in parallel, in combination, in loops, or in any order.

According to the method 520, a user equipment (UE) device receives first signaling information from a first base station (BS) (block 522). The first signaling information indicates that the UE device is to determine an index of each of a plurality of first synchronization signal blocks (SSBs) transmitted by a plurality of second BS to the UE device on a plurality of second component carriers, based on timing information regarding a first component carrier associated with the first BS.

In some implementations, the first component carrier can be associated with a first subcarrier spacing (SCS), and each of the plurality of second component carriers can be associated with a different respective SCS different from the first SCS.

In some implementations, the first signaling information can indicate that a value of an information element deriveSSB-IndexFromCell-inter is true.

The UE device determines a plurality of measurement windows for measuring one or more characteristics of the plurality of first SSBs (block 524). Each of the plurality of measurement windows can be determined based on a corresponding time offset value Δt, and an expected length of a corresponding one of the first SSBs.

In some implementations, determining each of the plurality of measurement windows includes determining that a start of that measurement window is the corresponding time offset value Δt prior to a sequentially first symbol of a corresponding SSB transmitted by the first BS to the UE device using a first component carrier. Determining each of the plurality of measurement windows can also include determining that a length of that measurement window is two times the corresponding time offset value Δt plus an expected length of the corresponding one of the first SSBs.

In some implementations, the time offset value Δt can present a difference in synchronization between (i) signals transmitted by the first BS to the UE device using the first component carrier, and (ii) at least one of signals transmitted by the plurality of second BS to the UE device using the plurality of second component carriers.

The UE device identifies, based on second signaling information received at the UE device from the first BS, a particular one of the plurality of second component carriers (block 526).

Further, the UE device measures, during a corresponding measurement window of the identified second component carrier, the one or more characteristics of a corresponding one of the first SSBs on the identified second component carrier (block 528).

In some implementations, the method 520 also includes transmitting data to the first BS outside of the plurality of measurement windows and/or receiving data from the first BS outside of the plurality of measurement windows. In some implementations, the method 520 also includes refraining from transmitting data to the first BS or receiving data from the first BS during the plurality of measurement windows.

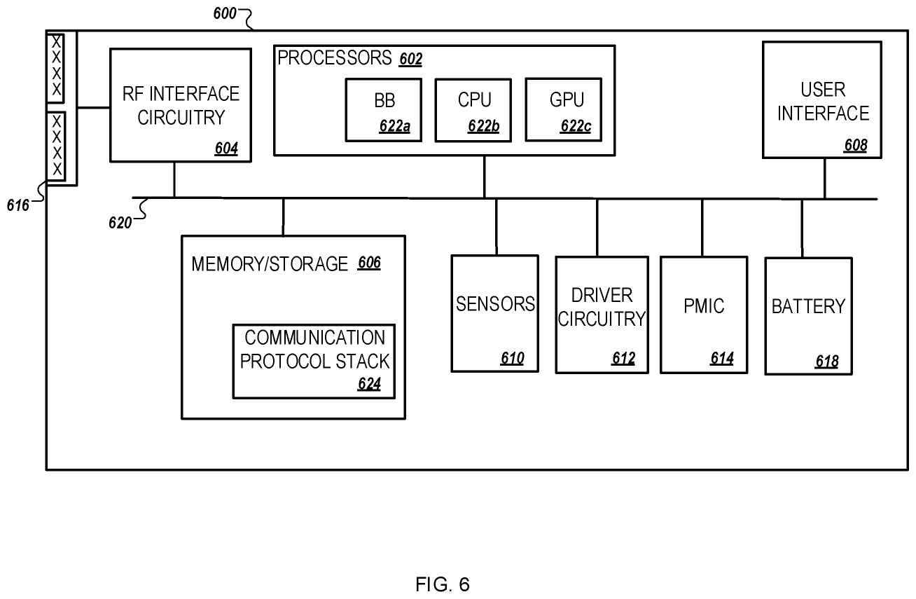

FIG. 6 illustrates a UE 600, in accordance with some embodiments. The UE 600 may be similar to and substantially interchangeable with UE 102 of FIG. 1.

The UE 600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some embodiments, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 604. The baseband processor circuitry 622A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some embodiments, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616.

In various embodiments, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some embodiments, the PMIC 614 may control, or otherwise be part of, various power saving mechanisms of the UE 600 including DRX as discussed herein. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

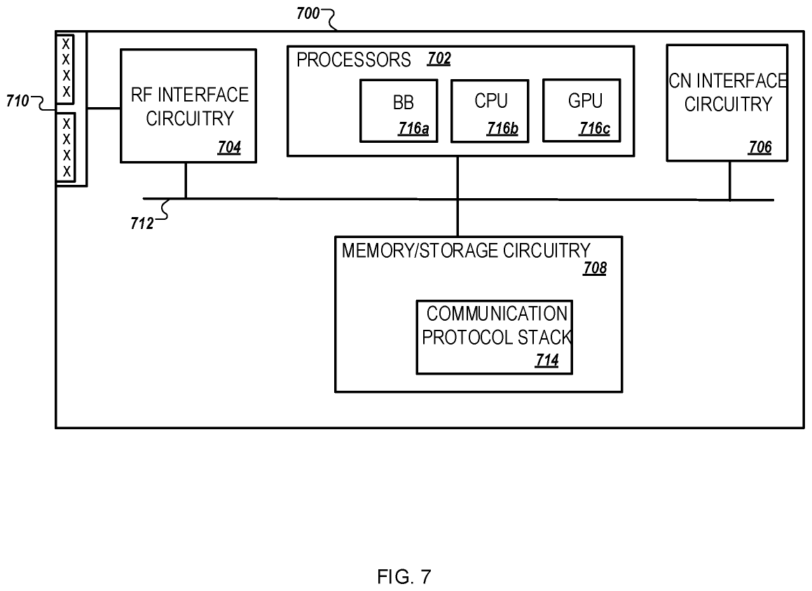

FIG. 7 illustrates an access node 700 (e.g., a base station or gNB), in accordance with some embodiments. The access node 700 may be similar to and substantially interchangeable with base station 104. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various embodiments, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 700 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 700; a MAC/PHY split wherein RRC, PDCP, RLC, and MAC layers are operated by the CRAN/vBBUP and the PHY layer is operated by the access node 700; or a “lower PHY” split wherein RRC, PDCP, RLC, MAC layers and upper portions of the PHY layer are operated by the CRAN/vBBUP and lower portions of the PHY layer are operated by the access node 700.

In V2X scenarios, the access node 700 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example A1 may include a method that includes receiving, at a user equipment (UE) device, first signaling information from a first base station (BS). The first signaling information can indicate that the UE device is to determine an index of a first synchronization signal block (SSB) transmitted by a second BS to the UE device on a second component carrier, based on timing information regarding a first component carrier associated with the first BS. Further, the method can include determining, by the UE device, a first measurement window for measuring one or more characteristics of the first SSB. The first measurmeent window can be determined based on a first time offset value Δt₁ and an expected length of the first SSB. Further, the method can include measuring, by the UE device, the one or more characteristics of the first SSB on the second carrier during the first measurement window.

Example A2 may include the method of claim A1, or portiosn thereof. Further, determining the first measurement window can include: determining that a start of the first measurement window is the first time offset value Δt₁ prior to a sequentially first symbol of a second SSB transmitted by the first BS to the UE device using the first component carrier; and determining that a length of the first measurement window is two times the first time offset value Δt₁ plus the expected length of the first SSB.

Example A3 may include the method of any one of Examples A1 or A2, or portions thereof. The method can also include at least one of: transmitting data to the first BS outside of the first measurement window, or receiving data from the first BS outside of the first measurement window.

Example A4 may include the method of any one of Examples A1-A3, or portions thereof. Further, the method can include refraining from transmitting data to the first BS or receiving data from the first BS during the first measurement window.

Example A5 may include the method of any one of Examples A1-A4, or portions thereof. Further, the first time offset value Δt₁ can represent a difference in synchronization between (i) first wireless signals transmitted by the first BS to the UE device using the first component carrier, and (ii) second wireless signals transmitted by the second BS to the UE device using the second component carrier.

Example A6 may include the method of any one of Examples A1-A5, or portions thereof. Further, the first component carrier can be associated with a first subcarrier spacing (SCS), and the second component carrier can be associated with a second SCS different from the first SCS.

Example A7 may include the method of any one of Examples A1-A6, or portions thereof. Further, the first signaling information can indicate that a value of an information element deriveSSB-IndexFromCell-inter is true.

Example A8 may include the method of any one of Examples A1-A7, or portions thereof. Further, the expected length of the first SSB can be determined based on second signaling information transmitted by the first BS to the UE device.

Example A9 may include the method of any one of Examples A1-A8, or portions thereof. Further, the second signaling information can include an information element SSB-ToMeasure.

Example A10 include the method of any one of Examples A1-A9, or portions thereof. Further, the first signaling information can further indicate that UE device is to determine an index of a third SSB transmitted by the second BS or a third BS to the UE device on the second component carrier or a third component carrier, based on the timing information regarding the first component carrier associated with the first BS. Further, the method can further include: determining, by the UE device, a second measurement window for measuring one or more characteristics of the third SSB, wherein the second measurement window is determined based on a second time offset value Δt₂ and an expected length of the third SSB; and measuring, by the UE device, the one or more characteristics of the third SSB on the second component carrier or the third component carrier during the second measurement window.

Example A11 may include the method of any one of Examples A1-A10, or portions thereof. Further, determining the second measurement window can include: determining that a start of the second measurement window is the second time offset value Δt₂ prior to a sequentially first symbol of a fourth SSB transmitted by the first BS to the UE device using the first component carrier, and determining that a length of the second measurement window is two times the second time offset value Δt₂ plus the expected length of the third SSB.

Example A12 may include the method of any one of Examples A1-A11, or portions thereof. The method can also include determining that the first measurement window at least partially overlaps the second measurement window, and responsive to determining that the first measurement window at least partially overlaps the second measurement window, merging the first measurement window and the second measurement window in a merged measurement window.

Example A13 may include the method of any one of Examples A1-A12, or portions thereof. The method can also include at least one of: transmitting data to the first BS outside of the merged measurement window, or receiving data from the first BS outside of the merged measurement window.

Example A14 may include the method of any one of Examples A1-A13, or portions thereof. The method can also include refraining from transmitting data to the first BS or receiving data from the first BS during the merged measurement window.

Example A15 may include the method of any one of Examples A1-A14, or portions thereof. Further, at least one of the first time offset value Δt₁ or the second time offset value Δt₂ can represent a difference in synchronization between (i) wireless signals transmitted by the first BS to the UE device using the first component carrier, and (ii) wireless signals transmitted by the second BS to the UE device using the second component carrier.

Example B6 may include the method of any one of Examples A1-A15, or portions thereof. Further, the second time offset value Δt₂ can represent a difference in synchronization between (i) wireless signals transmitted by the first BS to the UE device using the first component carrier, and (ii) wireless signals transmitted by the third BS to the UE device using the third component carrier.

Example A16 may include the method of any one of Examples A1-A16, or portions thereof. Further, the first component carrier can be associated with a first subcarrier spacing (SCS). The second component carrier can be associated with a second SCS different from the first SCS. The third component carrier can be associated with a third SCS different from the first SCS.

Example A17 may include the method of any one of Examples A1-A17, or portions thereof. Further, the first signaling information can indicate that a value of an information element deriveSSB-IndexFromCell-inter is true.

Example A18 may include the method of any one of Examples A1-A18, or portions thereof. Further, at least one of the expected length of the second SSB or the expected length of the third SSB cam be determined based on second signaling information transmitted by the first BS to the UE device.

Example A19 may include the method of any one of Examples A1-A19, or portions thereof. Further, the second signaling information can include an information element SSB-ToMeasure.

Example B1 may include a method that includes receiving, at a user equipment (UE) device from a first base station (BS), first signaling information. The first signaling information can indicate that the UE device is to determine an index of each of a plurality of first synchronization signal blocks (SSBs) transmitted by a plurality of second BS to the UE device on a plurality of second component carriers, based on timing information regarding a first component carrier associated with the first BS. Further, the method can include determining, by the UE device, a plurality of measurement windows for measuring one or more characteristics of the plurality of first SSBs. Each of the plurality of measurement windows is determined based on a corresponding time offset value Δt, and an expected length of a corresponding one of the first SSBs. Further, the method can include identifying, based on second signaling information received at the UE device from the first BS, a particular one of the plurality of second component carriers. Further, the method can include measuring, during a corresponding measurement window of the identified second component carrier, the one or more characteristics of a corresponding one of the first SSBs on the identified second component carrier.

Example B2 may include the method of Example B1, or portions thereof. Further, determining each of the plurality of measurement windows can include: determining that a start of that measurement window is the corresponding time offset value Δt prior to a sequentially first symbol of a corresponding second SSB transmitted by the first BS to the UE device using a first component carrier; and determining that a length of that measurement window is two times the corresponding time offset value Δt plus the expected length of the corresponding one of the first SSBs.

Example B3 may include the method of any one of Examples B1 or B21, or portions thereof. The method can also include at least one of: transmitting data to the first BS outside of the plurality of measurement windows, or receiving data from the first BS outside of the plurality of measurement windows.

Example B4 may include the method of any one of Examples B1-B3, or portions thereof. The method can also include refraining from transmitting data to the first BS or receiving data from the first BS during the plurality of measurement windows.

Example B5 may include the method of any one of Examples B1-B4, or portions thereof. Further, the time offset value Δt can represent a difference in synchronization between (i) signals transmitted by the first BS to the UE device using the first component carrier, and (ii) at least one of signals transmitted by the plurality of second BS to the UE device using the plurality of second component carriers.

Example B6 may include the method of any one of Examples B1-B5, or portions thereof. Further, the first component carrier can be associated with a first subcarrier spacing (SCS). Each of the plurality of second component carriers can be associated with a different respective SCS different from the first SCS.

Example B7 may include the method of any one of Examples B1-B6, or portions thereof. Further, the first signaling information can indicate that a value of an information element deriveSSB-IndexFromCell-inter is true.

Example C1: A non-transitory computer storage medium encoded with instructions that, when executed by one or more computers, cause the one or more computers to perform the method of any of Examples A1-A8, B1-B9, or C1-C6, or any other method or process described herein.

Example D1: A system include one or more computers and one or more storage devices on which are stored instructions that are operable, when executed by the one or more computers, to cause the one or more computers to perform the method of any of Examples A1-A19 and B1-B7, or any other method or process described herein.

Example E1 may include an apparatus having logic, modules, or circuitry to perform one or more elements of a method described in or related to any of Examples A1-A19 and B1-B7, or any other method or process described herein.

Example F1 may include a method, technique, or process as described in or related to any of Examples A1-A19 and B1-B7, or portions or parts thereof.

Example G1 may include an apparatus having: one or more processors and one or more computer-readable media having instructions that, when executed by the one or more processors, cause the one or more processors to perform the method, techniques, or process as described in or related to any of Examples A1-A19 and B1-B7, or portions thereof.

Example H1 may include a signal as described in or related to any of Examples A1-A19 and B1-B7, or portions or parts thereof.

Example I1 may include a datagram, information element, packet, frame, segment, PDU, or message as described in or related to any of Examples A1-A19 and B1-B7, or portions or parts thereof, or otherwise described in the present disclosure.

Example J1 may include a signal encoded with data as described in or related to any of Examples A1-A19 and B1-B7, or portions or parts thereof, or otherwise described in the present disclosure.

Example K1 may include a signal encoded with a datagram, IE, packet, frame, segment, PDU, or message as described in or related to any of Examples A1-A19 and B1-B7, or portions or parts thereof, or otherwise described in the present disclosure.

Example L1 may include an electromagnetic signal carrying computer-readable instructions, wherein execution of the computer-readable instructions by one or more processors is to cause the one or more processors to perform the method, techniques, or process as described in or related to any of Examples A1-A19 and B1-B7, or portions thereof.

Example M1 may include a computer program having instructions, wherein execution of the program by a processing element is to cause the processing element to carry out the method, techniques, or process as described in or related to any of Examples A1-A19 and B1-B7, or portions thereof. The operations or actions performed by the instructions executed by the processing element can include the methods of any one of Examples A1-A19 and B1-B7.

Example N1 may include a signal in a wireless network as shown and described herein.

Example O1 may include a method of communicating in a wireless network as shown and described herein.

Example P1 may include a system for providing wireless communication as shown and described herein. The operations or actions performed by the system can include the methods of any one of Examples A1-A19 and B1-B7.

Example Q1 may include a device for providing wireless communication as shown and described herein. The operations or actions performed by the device can include the methods of any one of Examples A1-A19 and B1-B7.

The previously-described Examples A1-R1 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus comprising one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of Examples A1-A19 and B1-B7.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more baseband processors configured to perform operations comprising:
receiving first signaling information from a first base station (BS), wherein the first signaling information indicates that a user equipment (UE) is to determine an index of a first synchronization signal block (SSB) transmitted by a second BS to the UE on a second component carrier, based on timing information regarding a first component carrier associated with the first BS;
determining a first measurement window for measuring one or more characteristics of the first SSB, wherein the first measurement window is determined based on a first time offset value Δt₁ and an expected length of the first SSB; and
measuring the one or more characteristics of the first SSB on the second carrier during the first measurement window.

2. The one or more baseband processors of claim 1, wherein determining the first measurement window comprises:
determining that a start of the first measurement window is the first time offset value Δt₁ prior to a sequentially first symbol of a second SSB transmitted by the first BS to the UE using the first component carrier, and
determining that a length of the first measurement window is two times the first time offset value Δt₂ plus the expected length of the first SSB.

3. The one or more baseband processors of claim 1, the operations further comprising at least one of:
transmitting data to the first BS outside of the first measurement window, or
receiving data from the first BS outside of the first measurement window.

4. The one or more baseband processors of claim 1, the operations further comprising:
refraining from transmitting data to the first BS or receiving data from the first BS during the first measurement window.

5. The one or more baseband processors of claim 1, wherein the first time offset value Δt₁ represents a difference in synchronization between (i) first wireless signals transmitted by the first BS to the UE using the first component carrier, and (ii) second wireless signals transmitted by the second BS to the UE using the second component carrier.

6. The one or more baseband processors of claim 1, wherein the first component carrier is associated with a first subcarrier spacing (SCS), and wherein the second component carrier is associated with a second SCS different from the first SCS.

7. The one or more baseband processors of claim 1, wherein the first signaling information indicates that a value of an information element deriveSSB-IndexFromCell-inter is true.

8. The one or more baseband processors of claim 1, wherein the expected length of the first SSB is determined based on second signaling information transmitted by the first BS to the UE, and
wherein the second signaling information comprises an information element SSB-ToMeasure

9. (canceled)

10. The one or more baseband processors of claim 2, wherein the first signaling information further indicates that UE is to determine an index of a third SSB transmitted by the second BS or a third BS to the UE on the second component carrier or a third component carrier, based on the timing information regarding the first component carrier associated with the first BS; and
wherein the method further comprises:
determining a second measurement window for measuring one or more characteristics of the third SSB, wherein the second measurement window is determined based on a second time offset value Δt₂ and an expected length of the third SSB; and
measuring the one or more characteristics of the third SSB on the second component carrier or the third component carrier during the second measurement window.

11. The one or more baseband processors of claim 10, wherein determining the second measurement window comprises:
determining that a start of the second measurement window is the second time offset value Δt₂ prior to a sequentially first symbol of a fourth SSB transmitted by the first BS to the UE using the first component carrier, and
determining that a length of the second measurement window is two times the second time offset value Δt₂ plus the expected length of the third SSB.

12. The one or more baseband processors of claim 10, the operations further comprising:
determining that the first measurement window at least partially overlaps the second measurement window; and
responsive to determining that the first measurement window at least partially overlaps the second measurement window, merging the first measurement window and the second measurement window in a merged measurement window.

13. The one or more baseband processors of claim 12, the operations further comprising at least one of:
transmitting data to the first BS outside of the merged measurement window, or
receiving data from the first BS outside of the merged measurement window.

14. The one or more baseband processors of claim 12, the operations further comprising:
refraining from transmitting data to the first BS or receiving data from the first BS during the merged measurement window.

15. The one or more baseband processors of claim 10, wherein at least one of the first time offset value Δt₁ or the second time offset value Δt₂ represents a difference in synchronization between (i) wireless signals transmitted by the first BS to the UE device using the first component carrier, and (ii) wireless signals transmitted by the second BS to the UE using the second component carrier.

16. The one or more baseband processors of claim 10, wherein the second time offset value Δt₂ represents a difference in synchronization between (i) wireless signals transmitted by the first BS to the UE using the first component carrier, and (ii) wireless signals transmitted by the third BS to the UE using the third component carrier.

17. The one or more baseband processors of claim 10, wherein the first component carrier is associated with a first subcarrier spacing (SCS), wherein the second component carrier is associated with a second SCS different from the first SCS, and wherein the third component carrier is associated with a third SCS different from the first SCS.

18. The one or more baseband processors of claim 10, wherein the first signaling information indicates that a value of an information element deriveSSB-IndexFromCell-inter is true.

19. The one or more baseband processors of claim 10, wherein at least one of the expected length of the second SSB or the expected length of the third SSB is determined based on second signaling information transmitted by the first BS to the UE, and
wherein the second signaling information comprises an information element SSB-ToMeasure

20-31. (canceled)

32. A method comprising:
receiving first signaling information from a first base station (BS), wherein the first signaling information indicates that a user equipment (UE) is to determine an index of a first synchronization signal block (SSB) transmitted by a second BS to the UE on a second component carrier, based on timing information regarding a first component carrier associated with the first BS;
determining a first measurement window for measuring one or more characteristics of the first SSB, wherein the first measurement window is determined based on a first time offset value Δt₁ and an expected length of the first SSB; and
measuring the one or more characteristics of the first SSB on the second carrier during the first measurement window.

33. A user equipment (UE) comprising:
one or more processors; and
memory storing instructions that when executed by the one or more processors, cause the base station one or more processors to perform operations comprising:
receiving first signaling information from a first base station (BS), wherein the first signaling information indicates that the UE is to determine an index of a first synchronization signal block (SSB) transmitted by a second BS to the UE on a second component carrier, based on timing information regarding a first component carrier associated with the first BS;
determining a first measurement window for measuring one or more characteristics of the first SSB, wherein the first measurement window is determined based on a first time offset value Δt₁ and an expected length of the first SSB; and
measuring the one or more characteristics of the first SSB on the second carrier during the first measurement window.
